(19) United States
(12) Patent Application Publication
(10) Pub. No.: US 2021/0049656 A1
(43) Pub. Date: Feb. 18, 2021

(54) CUSTOMER EXPERIENCE SCORING ON MOBILE NETWORK SYSTEMS AND METHODS

(71) Applicant: T-Mobile USA, Inc., Bellevue, WA (US)

(72) Inventors: Khrum Kashan Jat, Sammamish, WA (US); Gary Dousson, Seattle, WA (US); Dillon Camp, Bellevue, WA (US); Jatinder Sandhu, Bellevue, WA (US); Otto Fonseca Escudero, Snoqualmie, WA (US)

(21) Appl. No.: 16/541,121

(22) Filed: Aug. 14, 2019

(51) Int. Cl. G06Q 30/02

(52) U.S. Cl. CPC G06Q 30/0282; G06Q 30/0203

(57) ABSTRACT

Systems and methods for overall customer experience and scoring system to compute an overall score for each customer of a telecommunications service provider based on one or more customer-experience factors are disclosed. The customer scoring system selects a subset of customer-experience factors and for certain sectors, it computes a score value and a weight value for each customer-experience factor. Using these computed values, the system computes, for the customer, a customer network user experience score for the sector. The system then computes an overall customer network user experience score for the customer using the computed customer network user experience scores and a weight value of each sector. Computing and assigning an overall score to each customer helps the system to understand and differentiate between customer experiences in various markets, and identify customer experience enhancement actions to perform in various market.

### BACKGROUND

A telecommunications network is established via a complex arrangement and configuration of many cell sites that are deployed across a geographical area. For example, there can be different types of cell sites (e.g., macro cells, microcells, and so on) positioned in a specific geographical location, such as a city, neighborhood, and so on. These cell sites strive to provide adequate, reliable coverage for mobile devices (e.g., smart phones, tablets, and so on) via different frequency bands and radio networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network, 5G mobile communications network, IEEE 802.11 (WiFi), or other communications networks. The devices can seek access to the telecommunications network for various services provided by the network, such as services that facilitate the transmission of data over the network and/or provide content to the devices.

As device usage continues to rise at an impressive rate, there are too many people using too many network- (and/or data-) hungry applications in places where the wireless edge of the telecommunications network has limited or no capacity. As a result, most telecommunications networks have to contend with issues of network congestion. Network congestion is the reduced quality of service that occurs when a network node carries more data than it can handle. Typical effects include queueing delay, packet loss, or the blocking of new connections, resulting in an overall degraded customer experience. As a result, a customer's experience with a network suffers and oftentimes results in a customer switching telecommunications service providers.

### BRIEF DESCRIPTION OF THE DRAWINGS

FIG. 1 is a block diagram illustrating a suitable computing environment within which to score customer experience within a telecommunications network.

FIG. 2 is a block diagram illustrating the components of the customer scoring system.

FIG. 3 is a flow diagram illustrating a process of scoring customer experience in a telecommunications network.

FIGS. 4A-4C are example diagrams illustrating processes (or components of processes) of scoring customer experience in a telecommunications network.

FIGS. 5-6 are example reports illustrating comparison of customer experiences in a telecommunications network.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

Existing solutions tackle congestion problems at a macro level by deploying solutions at congested macro cell sites. But, they are unable to tackle problems experienced by individual customers in different markets/regions. Nor are they able to determine and/or differentiate between overall customer experiences at individual markets/regions, and thus miss opportunities to offer customized/personalized products, service, advertisements, etc. to customers.

To solve these and other problems, the inventors have developed an overall customer experience and scoring system (“customer scoring system”) and method to compute an overall score for each customer of a telecommunications service provider based on one or more customer-experience factors. Each customer-experience factor is related to customer experience, customer behavior, or customer description, and so on. The customer scoring system selects a subset of customer-experience factors based on an importance rating associated with each customer-experience factor in a set of customer-experience factors. Then, for each cell site (and/or service sectors within the cell site) serviced by the telecommunications service provider where a customer has been present, the customer scoring system computes, for the customer, a score value for each customer-experience factor in the subset of customer-experience factors. The customer scoring system also computes, for the customer, a weight value for each customer-experience factor in the subset of customer-experience factors. Using the computed score values and the computed weight values, the customer scoring system computes, for the customer, a customer network user experience score for the cell site (and/or sector). While the rest of this discussion uses the term sector, one of skill in the art would understand that the same discussion can apply to cell sites or other similar entities. The customer scoring system further computes or determines, for the sector, a traffic weight based on an amount of traffic routed through the sector. Then, the customer scoring system computes an overall customer network user experience score for the customer using: (1) the computed customer network user experience scores for each sector in the set of sectors, and (2) the computed traffic weight for each sector in the set of sectors. Computing and assigning an overall score to each customer helps the customer scoring system understand and differentiate between customer experiences in various markets and regions. Overall understanding and improving customer experience for each customer is key for customer satisfaction and retainability. And it also opens many opportunities to improve and for targeted marketing for them.

The customer scoring system can then use this overall customer score for each customer to customize and personalize the customer's experience, to help identify personalized products and/or services to offer to the customer, identify advertisements to offer to the customer, perform capacity planning, perform customer segmentation, perform churn analysis, and so on. For example, the customer scoring system can identify that capacity improvement solutions (e.g., adding a femtocell) should be offered to (and/or deployed for) customers in a market where a majority of the customers have a score below a certain threshold or value (e.g., a value of 3 out of 10). As another example, the customer scoring system can be used to compare two different markets based on the overall customer scores for customers belonging to the markets as follows: Market A, which has 40% of customers with an overall score greater than 8, is considered to be a better rated market than Market B, where only 10% of customers have an overall score greater than 8. As another example, the customer scoring system can offer new products related to security and/or broadband to customers having a high score (e.g., score greater than a threshold, such as 8).

In the following description, for the purposes of explanation, numerous specific details are set forth in order to provide a thorough understanding of implementations of the present technology. It will be apparent, however, to one skilled in the art, that implementations of the present technology can be practiced without some of these specific details.

The phrases “in some implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Suitabe Computing Environments

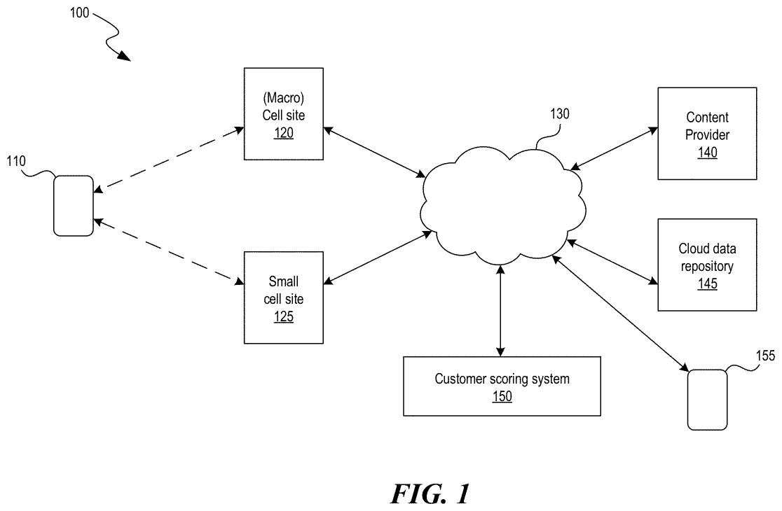

FIG. 1 is a block diagram illustrating a suitable computing environment 100 within which to determine customer experience scores, which can then be used to understand and/or differentiate a customer's experience in different markets and regions, offer services/products, perform churn analysis, perform capacity planning, and so on.

One or more user devices 110, such as mobile devices or user equipment (UE), associated with users (such as mobile phones (e.g., smartphones), tablet computers, laptops, and so on), IoT devices, etc. receive and transmit data, stream content, and/or perform other communications or receive services over a telecommunications network 130, which is accessed by the user devices 110 over one or more cell sites 120, 125. For example, the user devices 110 can access a telecommunications network 130 via a cell site at a geographical location that includes the cell site, in order to transmit and receive data (e.g., stream or upload multimedia content) from various entities, such as a content provider 140, cloud data repository 145, and/or other user devices 155 on the telecommunications network 130 and via the cell site 120.

The cell sites can include macro cell sites 120, such as base stations, small cell sites 125, such as picocells, microcells, or femtocells, and/or other network access component or sites. The cell cites 120, 125 can store data associated with their operations, including data associated with the number and types of connected users, data associated with the provision and/or utilization of a spectrum, radio band, frequency channel, and so on, provided by the cell sites 120, 125, and so on. The cell sites 120, 125 can monitor their use, such as the provisioning or utilization of physical resource blocks (PRBs) provided by a cell site physical layer in LTE network; likewise, the cell sites can measure channel quality, such as via channel quality indicator (CQI) values, etc.

Other components provided by the telecommunications network 130 can monitor and/or measure the operations and transmission characteristics of the cell sites 120, 125, and other network access components. For example, the telecommunications network 130 can provide a network monitoring system, via a network resource controller (NRC) or network performance and monitoring controller, or other network control component, in order to measure and/or obtain the data associated with the utilization of cell sites 120, 125 when data is transmitted within a telecommunications network 130.

In some implementations, the computing environment 100 includes a customer scoring system 150 configured to monitor aspects of the telecommunications network 130 based on, for example, data received from the network monitoring system. The customer scoring system 150 can receive customer usage records to evaluate the quality of a customer's experience with a telecommunications service provider, and then identify one or more services/solutions to enhance the customer's experience.

FIG. 1 and the discussion herein provide a brief, general description of a suitable computing environment 100 in which the customer scoring system 150 can be supported and implemented. Although not required, aspects of the customer scoring system 150 are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the user devices 110 and/or the cell sites 120, 125 can include network communication components that enable the devices to communicate with remote servers or other portable electronic devices by transmitting and receiving wireless signals using a licensed, semi-licensed, or unlicensed spectrum over communications network, such as telecommunications network 130. In some cases, the telecommunications network 130 can be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The telecommunications network 130 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network, 5G mobile communications network, IEEE 802.11 (WiFi), or other communications networks. Thus, the user device is configured to operate and switch among multiple frequency bands for receiving and/or transmitting data.

Further details regarding the operation and implementation of the customer scoring system 150 will now be described.

### Example of Scoring Customer Experience and Deploying Improved Customer Experience Enhancement Solutions

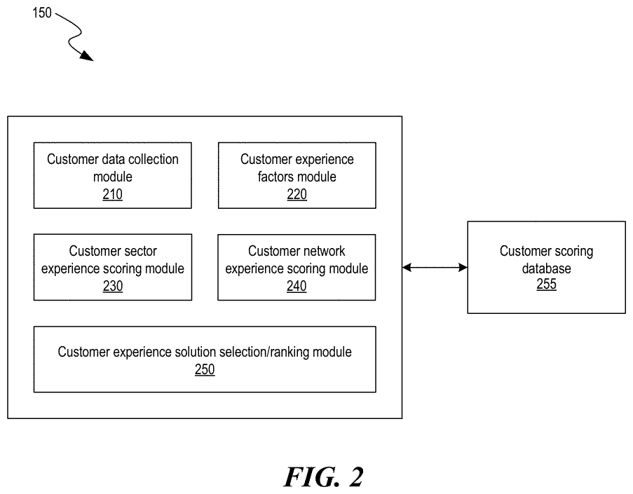

FIG. 2 is a block diagram illustrating the components of the customer scoring system 150. The customer scoring system 150 can include functional modules that are implemented with a combination of software (e.g., executable instructions, or computer code) and hardware (e.g., at least a memory and processor). Accordingly, as used herein, in some examples a module is a processor-implemented module or set of code, and represents a computing device having a processor that is at least temporarily configured and/or programmed by executable instructions stored in memory to perform one or more of the specific functions described herein. For example, the customer scoring system 150 can include a customer data collection module 210, a customer experience factors module 220, a customer sector experience scoring module 230, a customer network experience scoring module 240, and a customer experience solution selection/ranking module 250, each of which is discussed separately below.

### The Customer Data Collection Module 210

The customer data collection module 210 is configured and/or programmed to receive a customer's usage data when accessing services/utilities associated with a telecommunications network. The customer data collection module 210 collects/receives/accesses data records associated with customer experience, customer behavior, customer descriptions, etc. For example, the customer data collection module 210 can collect, receive or access data related to some or all the following types of information (which can be stored in the customer scoring database 255): location of specific records (LSR), call data records (CDRs), timing advance values, RF signal data (e.g., Reference Signal Received Power (RSRP) data, Reference Signal Received Quality (RSRQ) data), distance between the customer and at least one telecommunications network site, strength of signal, quantity of data used, customer network measurement, network sector capacity users (e.g., network sector capacity users per 5 MHz), type of device of the customer, applications data (e.g., application type, name, owner, manager, data sent/received/used/saved, bandwidth used, APIs accessed, etc.), source of records (for example, telecommunications service provider, third-party, application owner, etc.), history with the telecommunications service provider (for example, length of subscription, payment history, etc.), demographics (e.g., age, ethnicity, gender, locations, etc.), usage profiles (e.g., usage plans, number of lines, etc.), credit score, education profile, work history, dominant markets, retention, partnership usage, access failures, leakage, types of handsets, call drop rate, access failures, leakage, geographic locations of sectors in the set of sectors, number of sectors used, number of cell sites used, customer service records associated with the customer (e.g., customer feedback, service calls placed, etc.), latency, distance and/or speed of traveling, number and/or type of simultaneously connected devices, and so on.

The customer data collection module 210 can collect customer records that span a particular period of time depending on, for example, density of records, usage activity, types of records (for example, text, voice, video, app-usage, emergency services, etc.), services/products to be offered to the customer, types of customer experience enhancement solutions/actions to be implemented, source of usage records, and so on.

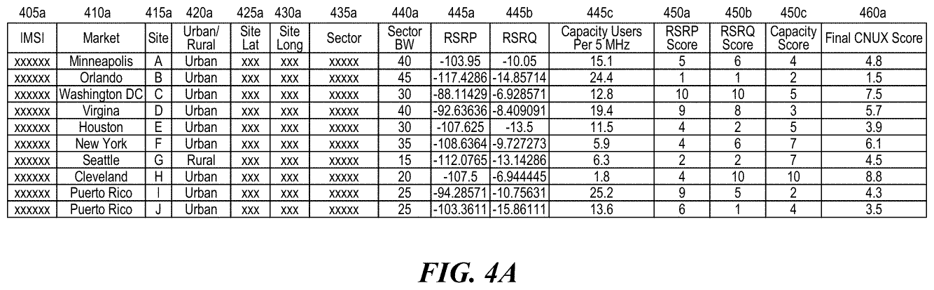

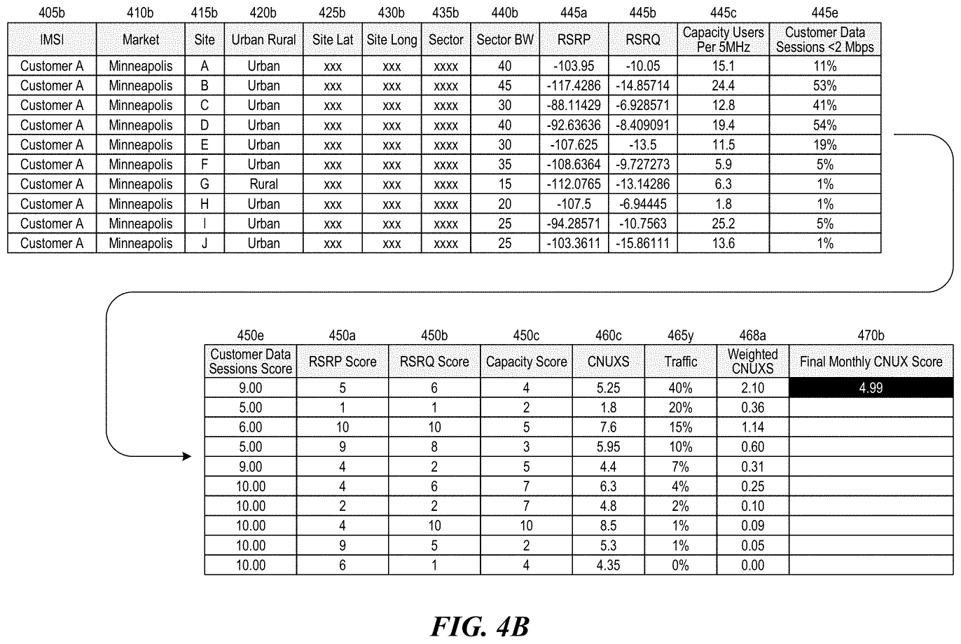

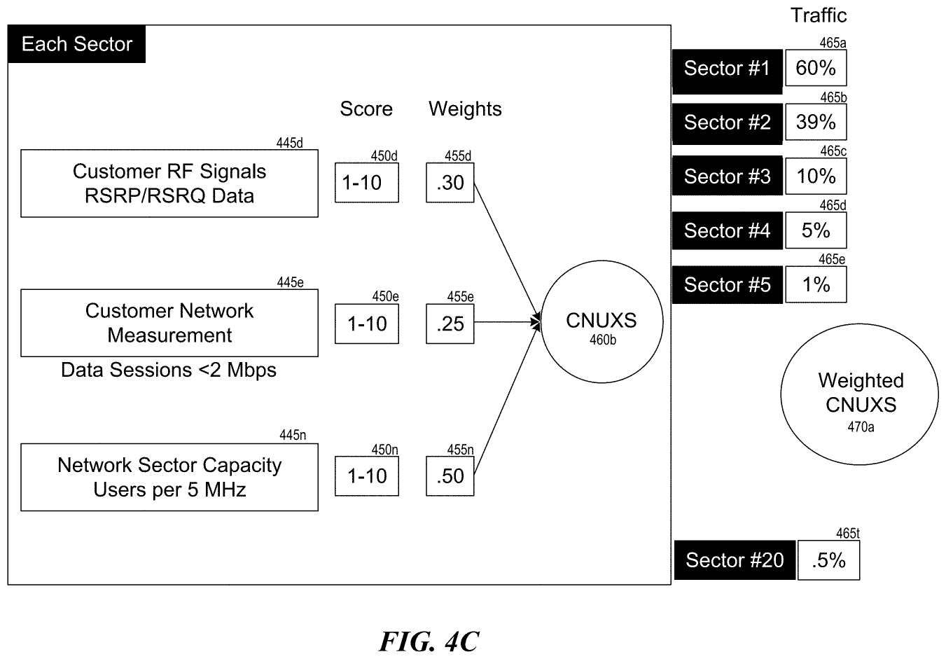

For example, as illustrated in FIGS. 4A-4C, the customer data collection module 210 collects the following customer data: IMSI 405a-405b, market 410a-410b, site 415a-415b, urban/rural indicator 420a-420b, site location (latitude 425a-425b and longitude 430a-430b), sector 435a-435b, sector bandwidth 440a-440b, customer RF signals 445d (e.g., RSRP 445a and RSRQ 445b), capacity users per 5 MHz 445c and 445n, customer network measurement 445e, and so on.

### The Customer Experience Factors Module 220

The customer experience factors module 220 is configured and/or programmed to select one or more customer-experience factors related to customer experience, customer behavior, customer description, and so on. Examples of customer-experience factors include, but are not limited to one or more of the following: customer RSRP, customer RSRQ, customer network measurement, network sector capacity users per threshold frequency, customer history with the telecommunications service provider, customer demographics, customer usage profile, customer credit score, partnership usage, types of handsets, customer payment history, call drop rate, access failures, leakage, geographic locations of sectors in the set of sectors, number of sectors used, number of cell sites used, customer service records associated with the customer, and so on. The customer experience factors module 220 can select the customer-experience factors based on importance ratings associated with each customer-experience factor. The importance ratings of customer-experience factors can be predetermined or determined dynamically based on, for example, feedback received from customers, crowdsourcing, correlation between customer-experience factors and the overall customer experience being measured, type of customer experience being measured, and so on.

### The Customer Sector Experience Scoring Module 230

The customer sector experience scoring module 230 is configured and/or programmed to compute customer experience scores for each customer in each sector utilized by the customer. The customer sector experience scoring module 230 can first identify the sectors utilized by a customer. For example, as shown in FIG. 4A, the customer sector experience scoring module 230 identifies at least one sector 435 associated with each IMSI 405 (which corresponds to a customer). Similarly, FIG. 4C illustrates that a customer utilizes twenty sectors (corresponding to multiple cell sites): sector #1, sector #2, . . . , sector #20.

After identifying the sectors utilized by a customer, the customer sector experience scoring module 230 computes a score value for one or more customer-experience factors (for example, those selected by the customer experience factors module 220). The customer experience factors module 220 can compute a score value for a customer-experience factor by first determining a range of values for the customer-experience factor. Then, the customer experience factors module 220 can divide the range of values into sub-ranges, each corresponding to a particular score value. For example, if the score range is from one to ten (1 to 10), then the customer experience factors module 220 can divide the range of values into ten equal percentile sub-ranges. The following tables help illustrate these computations:

TABLE 1
RSRP Scoring Table
(Range of values: −88 dBM to −117 dBM)

| Percentile | RSRP Score | RSRP [dBM] |
|---|---|---|
| 90-100th | 10 | >-89 |
| 80-90th | 9 | >-95 |
| 70-80th | 8 | >-98 |
| 60-70th | 7 | >-101 |
| 50-60th | 6 | >-104 |
| 40-50th | 5 | >-106 |
| 30-40th | 4 | >-109 |
| 20-30th | 3 | >-111 |
| 10-20th | 2 | >-114 |
| 0-10th | 1 | ≤-114 |

TABLE 2
RSRQ Scoring Table
(Range of values: −6 dB to −15 dB)

| Percentile | RSRQ Score | RSRQ [dB] |
|---|---|---|
| 90-100th | 10 | >-7.6 |
| 80-90th | 9 | >-8.4 |
| 70-80th | 8 | >-9.1 |
| 60-70th | 7 | >-9.7 |
| 50-60th | 6 | >-10.3 |
| 40-50th | 5 | >-10.9 |
| 40-50th | 4 | >-11.6 |
| 20-30th | 3 | >-12.4 |
| 10-20th | 2 | >-13.5 |
| 0-10th | 1 | ≤-13.5 |

TABLE 3
User Capacity Scoring Table
(Range of values: 1.8 to 25.2)

| | Capacity | RRC Connected |
|---|---|---|
| Percentile | Score | Users/5 MHz |
| 90-100th | 10 | <2.1 |
| 80-90th | 9 | <3.8 |
| 70-80th | 8 | <5.6 |
| 60-70th | 7 | <7.7 |
| 50-60th | 6 | <10.1 |
| 40-50th | 5 | <12.9 |
| 40-50th | 4 | <16.3 |
| 20-30th | 3 | <20.6 |
| 10-20th | 2 | <27.3 |
| 0-10th | 1 | ≥27.3 |

TABLE 4
Customer Data Sessions Scoring Table (number of sessions below 3 Mbps)
(Range of values: 1% to 54%)

| | | |
|---|---|---|
| 90-100th | 10 | ≤10% |
| 80-90th | 9 | ≤20% |
| 70-80th | 8 | ≤30% |
| 60-70th | 7 | ≤40% |
| 50-60th | 6 | ≤50% |
| 40-50th | 5 | ≤60% |
| 30-40th | 4 | ≤70% |
| 20-30th | 3 | ≤80% |
| 10-20th | 2 | ≤90% |
| 0-10th | 1 | ≤100% |

FIGS. 4A-4B illustrate the score values 450a, 450b, 450c, and 450e computed by the customer sector experience scoring module 230 for customer-experience factors 445a, 445b, 445c, and 445e respectively. Similarly, FIG. 4C illustrates the score value ranges 450d, 450e, and 450n for customer-experience factors 445d, 445e, and 445n respectively.

In some implementations, the customer sector experience scoring module 230 receives a range of values for a customer-experience factor, divides the range of values for the customer-experience factor into at least two subsets of values, and computes the score value for the customer-experience factor by comparing a value of the customer-experience factor when the customer is present in a sector with the at least two subsets of values for the customer-experience factor.

In addition to computing the score values for each selected customer-experience factors, the customer sector experience scoring module 230 computes a weight value for the selected customer-experience factors. In some implementations, the customer sector experience scoring module 230 uses principal component analysis, correlation, and/or other similar techniques to compute the weights. For example, as illustrated in FIG. 4C, the customer sector experience scoring module 230 computes weights 455d, 445e, and 455n for customer-experience factors 445d, 445e, and 445n respectively.

After determining the score values and weight values for the selected customer-experience factors, the customer sector experience scoring module 230 computes a customer sector experience score for each sector. For example, the customer sector experience scoring module 230 can use the following formula to compute the customer sector experience score for a sector:

$$customer sector experience {score}_{sector} = {\sum }_{i = 1}^{n} customer - experience factor {score}_{i} * customer - experience factor {weight}_{i}$$

n=number of selected customer-experience factors

For example, as illustrated in FIG. 4C, the customer sector experience scoring module 230 computes a customer sector experience score (CNUXS) 460b for a selected sector. Similarly, FIGS. 4A illustrates a customer sector experience score 460a computed by the customer sector experience scoring module 230 for a particular sector utilized 435a by each customer 405a. And FIG. 4B illustrates a customer sector experience score 460c computed by the customer sector experience scoring module 230 for each sector 435b utilized by Customer A 405b. In this manner, the customer sector experience scoring module 230 can compute customer sector experience scores for multiple sectors. In some implementations, the customer sector experience scoring module 230 can then rank two or more sectors in increasing (or decreasing) order of each respective sector's computed customer sector experience score.

### The Customer Network Experience Scoring Module 240

The customer network experience scoring module 240 is configured and/or programmed to compute an overall customer network experience score. To do so, the customer network experience scoring module 240 determines/computes a weight for one or more sectors that were utilized by a customer. The weight for each sector can be based on one or more of the following factors: amount of traffic handled by the sector, location of the sector, type of services (e.g., 3G/4G/5G, etc.) offered by the sector, popularity of the sector, time spent in each sector, and so on. For example, as illustrated in FIGS. 4B-4C, the customer network experience scoring module 240 computes sector weights 465y, 465a, 465b, . . . , 465t respectively based on the amount of traffic handled by each sector.

The customer network experience scoring module 240 can then compute an overall customer network experience score for a customer using the individual customer sector experience score values and the respective sector weights. For example, as illustrated in FIG. 4B, the customer network experience scoring module 240 first computes a weighted customer sector experience score 468a as follows:

weighted customer sector experience score_{sector}=weight_{sector}*customer sector experience score_{sector}

Then, the customer network experience scoring module 240 computes an overall customer network experience score 470b as follows:

overall customer network experience score_{customer}=Σweighted customer sector experience score_{sector}

The customer network experience scoring module 240 can compute the overall customer network experience score over a predetermined period of time, such as daily, weekly, monthly, quarterly, yearly, and so on. The period of time can be based on one or more of the following: customer experience enhancement actions being considered, type of customer, density of records received by the customer data collection module 210, and so on. For example, the customer network experience scoring module 240 computes the overall customer network experience score monthly to maintain consistent experience and time to react on the changes and upgrade performed along the month. FIG. 4C illustrates an overall customer network experience score 470a computed by the customer network experience scoring module 240 for a customer.

In several implementations, instead of using computed score and weight values for all sectors utilized by a customer, the customer network experience scoring module 240 selects a subset of sectors to compute the overall customer network experience score. The customer network experience scoring module 240 can select the sectors based on one or more of the following factors: popularity of sector with the customer, popularity of sector with other customers, top sectors utilized by the customer, location of the sectors, type of services offered by the sector, and so on. For example, the customer network experience scoring module 240 selects the top 30-40 sectors for each customer, which contain 99% of customer usage in a month.

In several implementations, the customer network experience scoring module 240 divides the sectors utilized by a customer into two or more groups based on, for example, a location of the sector, popularity of sector with the customer, popularity of sector with other customers, top sectors utilized by the customer, location of the sectors, type of services offered by the sector, and so on. For example, the customer network experience scoring module 240 divides the sectors into the following groupings: home-related sectors, work-related sectors, mobility-related sectors, global sectors, and so on. After determining the sector subgroups (or subsets), the customer network experience scoring module 240 can compute an overall customer sector subset experience score for the particular sector subset using (1) the computed customer sector experience scores for each sector in the particular sector subset of sectors, and (2) the computed traffic weight for each sector in the particular subset of sectors. In some implementations, the customer network experience scoring module 240 can rank the sector subsets based on the overall customer sector subset experience scores for the sector subsets.

### The Customer Experience Solution Selection/Ranking Module 250

The customer experience solution selection/ranking module 250 is configured and/or programmed to identify at least one customer experience enhancement action capable of being performed at one or more identified sectors, the customer's device, and so on based on one or more of: the computed customer sector experience scores and/or the overall customer network experience score for the customer. The customer experience enhancement actions are intended to enhance overall customer experience. Examples of customer experience enhancement action include, but are not limited to: enhancing capabilities of identified sectors (e.g., adding/removing spectrum(s)), adding/removing cell site proximate to an identified site, displacing cell site proximate to a site, implementing a cell split, deploying a small cell, adding/removing a sector, enhancing sector capacity, adding/removing a cell on wheels, adding/removing a tower, adding/removing hot spots, modifying capacity at the identified at least one site, and so on. Additionally or alternatively, the customer experience enhancement action comprises providing one or more of the following services to the customer (free or at reduced rates for a period of time): fixed wireless, gaming, home security, music, videos, advertising, offers, rebates, location intelligence, upsales, partnerships with other companies, special content. For example, based on the customer's home location, the customer experience solution selection/ranking module 250 identifies offers for home security and restaurants in the vicinity of the identified home location.

The customer experience solution selection/ranking module 250 can select one or more customer experience enhancement actions and rank them according to one or more of the following factors: customer preferences, cost of implementation of action, timeline of implementation of action, customer location, discount offered, growth of traffic, new anticipated customers, competitive analysis, and so on. In some implementations, the customer experience solution selection/ranking module 250 transmits a list of selected customer experience enhancement actions to the telecommunications service provider so that one or more of the selected actions can be implemented to enhance the overall customer experience.

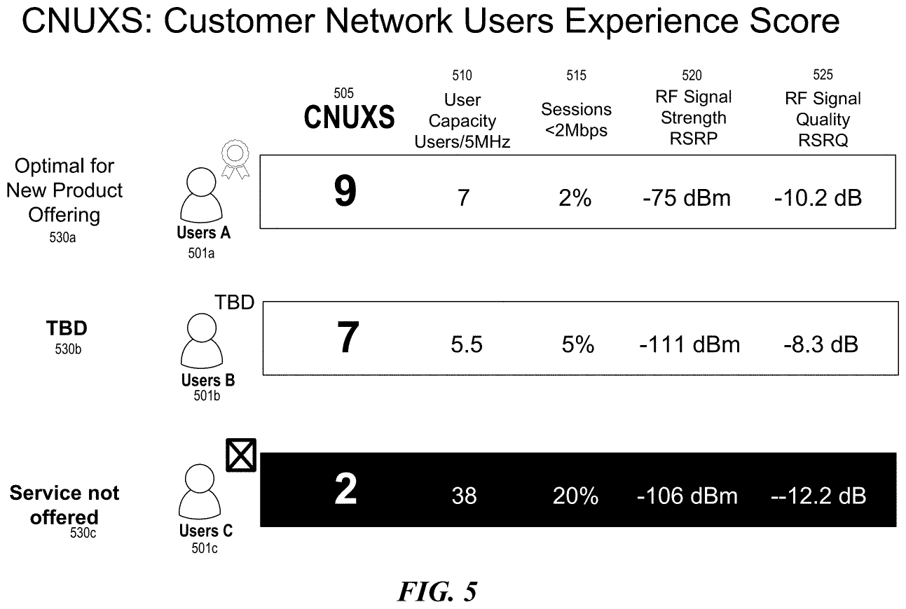

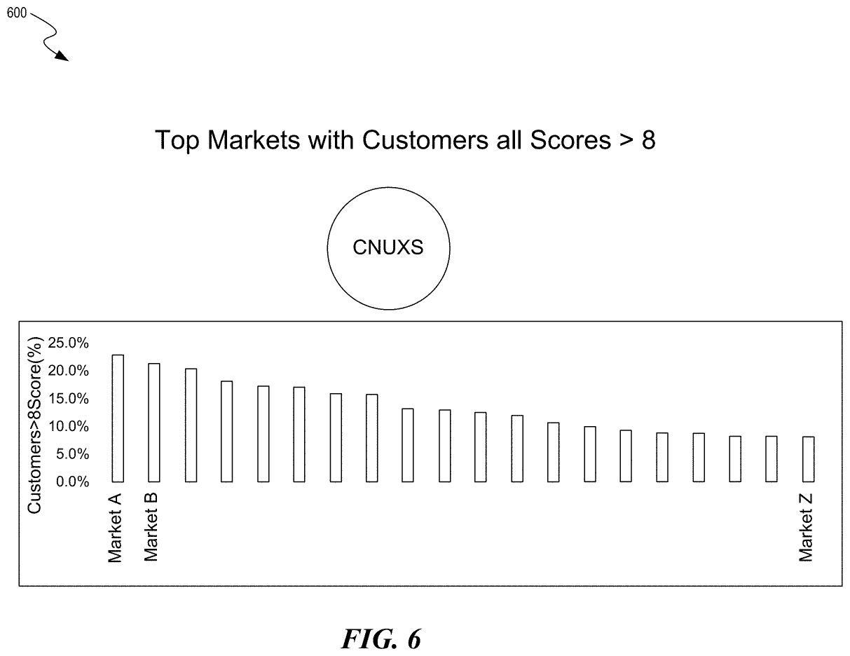

FIGS. 5-6 illustrate example reports generated by the customer experience solution selection/ranking module 250 to compare customer experience scores in a telecommunications network. The reports can compare scores of individual customers or sets of customers (e.g., by computing an average of the scores of customers in a set). For example, as illustrated in FIG. 5, the customer network users experience score 505 and individual customer experience factor values 510, 515, 520, and 525 of three sets of users—users A 501a, users B 501b, and users C 501c—are compared to determine which customer experience enhancement actions 530a, 530b, and 530c, if any, should be selected for the users. FIG. 6 illustrates a report 600 that depicts and compares markets where customer experience scores are greater than a threshold amount (e.g., 8). The customer experience solution selection/ranking module 250 can use these and other similar reports to identify markets where certain new products/services should be offered, estimate gains for launching products/services in markets, predict scores of new customers, perform churn analysis, and so on. As a result, a telecommunications service provider is better able to provide customized, personalized, and enhanced services to its customers, thus increasing its customer base and promoting customer stickiness. An advantage of having the customer score is that by knowing about each customer experience over the period of the month, a telecommunications service provider can plan and improve the customer experience. This can result in customers stay longer with the telecommunications service provider and can also help identify new revenue generating opportunities.

### Flow Diagrams

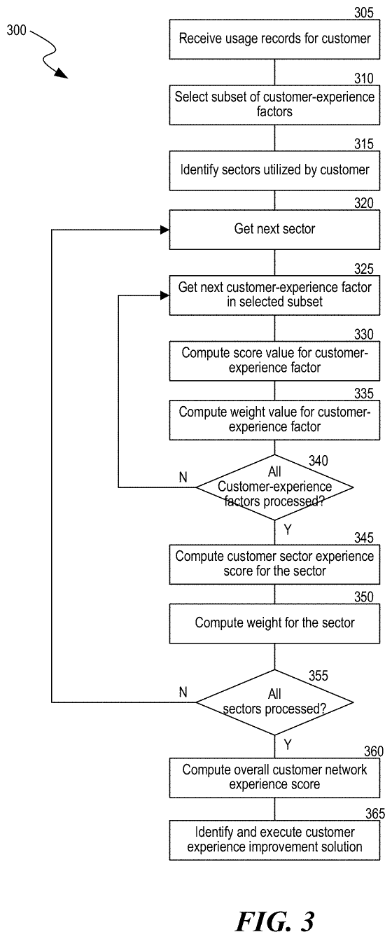

FIG. 3 is a flow diagram illustrating a process of scoring customer experience in a telecommunications network. Process 300 begins at block 305 where it receives a set of records associated with the customer (for example, usage records, customer data records, and so on). The record in the set of records can comprise information about sectors utilized by the customer. At block 310, process 300 selects a subset of customer-experience factors from a set of customer-experience factors. Each customer-experience factor is related to customer experience, customer behavior, or customer description. Process 300 can select the subset of customer-experience factors based on an importance rating associated with each customer-experience factor in the set of customer-experience factors. At block 315, process 300 identifies one or more sectors utilized by the customer by, for example, examining the data received in the set of records at block 305. In some implementations, process 300 can filter the identified sectors to eliminate noise and/or outliers. As discussed above, in some implementations, process 300 can divide the identified sectors in subsets (e.g., based on a location of each sector). Then, for each sector in a set of sectors serviced by the telecommunications service provider where a customer has been present (block 320), process 300 computes, for the customer, a score value for each customer-experience factor in the subset of customer-experience factors (blocks 325-330). At block 335, process 300 compute, for the customer, a weight value for each customer-experience factor in the subset of customer-experience factors.

After determining that all customer-experience factors are processed (block 340), process 300, at block 345 computes, for the customer, a customer sector experience score for the sector using the computed score values and the computed weight values. At block 350, process 300 computes, for the sector, a traffic weight based on an amount of traffic routed through the sector. After determining that all sectors (e.g., for the entire network, for a subset of sectors, etc.) are processed (block 355), process 300, at block 360 computes, for the customer, an overall customer network experience score (or an overall customer sector subset experience score) using (1) the computed customer sector experience scores for each sector in the set of sectors, and (2) the computed traffic weight for each sector in the set of sectors. At block 365, process 300 identifies and/or executes one or more customer experience improvement solutions based on one or more of the following: the computed overall customer network experience score, overall customer sector subset experience score, or customer sector experience score.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects can likewise be implemented in a computer-readable medium. Accordingly, the inventors reserve the right to add additional claims after filing the application to pursue such additional claim forms for other aspects of the technology.

1. A computer-implemented method for computing overall customer network experience scores for customers having an account with a wireless telecommunications service provider, the method comprising:
selecting a subset of customer-experience factors from a set of customer-experience factors, wherein each customer-experience factor is related to customer experience, customer behavior, or customer description, wherein the subset of customer-experience factors are selected based on
an importance rating associated with each customer-experience factor in the set of customer-experience factors;
for each service sector in a set of sectors serviced by the wireless telecommunications service provider where a customer has been present:
computing, for the customer, a score value for each customer-experience factor in the subset of customer-experience factors;
computing, for the customer, a weight value for each customer-experience factor in the subset of customer-experience factors;
computing, for the customer, a customer sector experience score for the sector using the computed score values and the computed weight values; and
computing, for the sector, a traffic weight based on an amount of traffic routed through the sector; and
computing, for the customer, an overall customer network experience score using (1) the computed customer sector experience scores for each sector in the set of sectors, and (2) the computed traffic weight for each sector in the set of sectors.

2. The method of claim 1, wherein the set of customer-experience factors comprises:
customer Reference Signal Received Quality (RSRQ),
customer network measurement,
network sector capacity users per threshold frequency,
customer history with the telecommunications service provider,
customer demographics,
customer usage profile,
customer credit score,
partnership usage,
types of handsets,
customer payment history,
call drop rate,
access failures,
leakage,
geographic locations of sectors in the set of sectors,
number of sectors used,
number of cell sites used,
customer service records associated with the customer,
or any combination thereof.

3. The method of claim 1 further comprising:
identifying at least one product or service to offer to the customer, or at least one advertisement to provide to the customer, based on the computed overall customer network experience score for the customer.

4. The method of claim 1 further comprising:
identifying at least one product or service to offer to the customer based on the computed overall customer network experience score for the customer,
wherein the at least one product or service is associated with one or more of the following:
fixed wireless,
home security,
type of telecommunications service,
gaming,
video,
partnerships with third-party vendors,
or any combination thereof.

5. The method of claim 1 further comprising:
identifying at least action to be performed at a selected sector in the set of sectors based on the computed overall customer network experience score of customers associated with the selected sector.

6. The method of claim 1, wherein the importance rating associated with each customer-experience factor in the set of customer-experience factors is predetermined.

7. The method of claim 1, wherein the importance rating associated with each customer-experience factor in the set of customer-experience factors is determined based on feedback received from a set of customers.

8. The method of claim 1, wherein the weight value for each customer-experience factor is computed using principal component analysis.

9. The method of claim 1 further comprising:
ranking at least a subset of sectors in the set of sectors based on the computed customer sector experience score of the sectors.

10. The method of claim 1, wherein the score value for a customer-experience factor is determined by:
receiving a range of values for the customer-experience factor;
dividing the range of values for the customer-experience factor into at least two subsets of values; and
computing the score value for the customer-experience factor by comparing a value of the customer-experience factor when the customer is present in a sector with the at least two subsets of values for the customer-experience factor.

11. A computer-implemented method for computing user network experience scores for users associated with a telecommunications service provider, the method comprising:
selecting a subset of user-experience factors from a set of user-experience factors, wherein each user-experience factor is related to user experience, user behavior, or user description,
wherein the subset of user-experience factors are selected based on an importance rating associated with each user-experience factor in the set of user-experience factors;
selecting at least two sector subsets from a set of sectors serviced by the telecommunications service provider where a user has been present, wherein the at least two sector subsets are selected based on a location associated with each sector in the set of sectors;
for each particular sector subset of the at least two sector subsets:
for each sector in the particular sector subset computing at least two of:
a score value for each user-experience factor in the subset of user-experience factors;
a weight value for each user-experience factor in the subset of user-experience factors;
a user sector experience score for the sector using the computed score values, the computed weight values, or both; and
a traffic weight based on an amount of traffic routed through the sector; and
computing an overall user sector subset experience score for the particular sector subset using (1) the computed user sector experience scores for each sector in the particular sector subset of sectors, (2) the computed traffic weight for each sector in the particular subset of sectors, or (3) both the computed user sector experience scores and the computed traffic weight or weights.

12. The method of claim 11, wherein a first sector subset of the at least two sector subsets or a second sector subset of the at least two sector subsets corresponds to:
a home location of the user,
a work location of the user,
a mobility location of the user, or
a global location of the user, and wherein the first sector subset is different from the second sector subset.

13. The method of claim 11, wherein the set of user-experience factors comprises:
user Reference Signal Received Power (RSRP),
user Reference Signal Received Quality (RSRQ),
user network measurement,
network sector capacity users per threshold frequency,
user history with the telecommunications service provider,
user demographics,
user usage profile,
user credit score,
partnership usage,
types of handsets,
user payment history,
call drop rate,
access failures,
leakage,
geographic locations of sectors in the set of sectors,
number of sectors used,
number of cell sites used,
user service records associated with the user,
or any combination thereof.

14. The method of claim 11 further comprising:
identifying at least one product or service to offer to the user, or at least one advertisement to provide to the user based on the computed overall user sector subset experience score for at least one sector subset of the at least two sector subsets.

15. The method of claim 11 further comprising:
identifying at least one product or service to offer to the user, or at least one advertisement to provide to the user based on a comparison of the computed overall user sector subset experience scores for the at least two sector subsets.

16. The method of claim 11 further comprising:
identifying at least one product or service to offer to the user, or at least one advertisement to provide to the user based on the computed overall user sector subset experience score for at least one sector subset of the at least two sector subsets,
wherein the at least one product or service is associated with one or more of the following:
fixed wireless,
home security,
type of telecommunications service,
gaming,
video,
partnership with a third-party vendor,
or any combination thereof.

17. The method of claim 11 further comprising:
ranking the sector subsets of the at least two sector subsets based on the overall user sector subset experience scores for the at least two sector subsets.

18. A computer-implemented method for computing customer network experience scores for customers associated with a telecommunications service provider, the method comprising:
selecting a subset of customer-experience factors from a set of customer-experience factors,
wherein each customer-experience factor is related to customer experience, customer behavior, or customer description; and
for each cell in a set of cells associated with the telecommunications service provider where a customer has been present:
computing, for the customer, a score value for each customer-experience factor in the subset of customer-experience factors;
computing, for the customer, a weight value for each customer-experience factor in the subset of customer-experience factors; and
computing, for the customer, a customer sector experience score for the sector using the computed score values and the computed weight values.

19. The method of claim 18 further comprising:
ranking the sectors in the set of sectors based on the customer sector experience scores for the sectors.

20. The method of claim 18, wherein the score value for a customer-experience factor is determined by:
receiving a range of values for the customer-experience factor;
dividing the range of values for the customer-experience factor into at least two subsets of values; and
computing the score value for the customer-experience factor by comparing a value of the customer-experience factor when the customer is present in a sector with the at least two subsets of values for the customer-experience factor.
